(19) United States
(12) Patent Application Publication
(10) Pub. No.: US 2026/0203197 A1
(43) Pub. Date: Jul. 16, 2026

(54) AUTOMATED CONTROL OF SOFTWARE DEVELOPMENT PIPELINE PROGRESSION

(71) Applicant: SAP SE, Walldorf (DE)

(72) Inventors: Ralf Schroth, Bad Schoenborn (DE); Andreas Schoknecht, Linkenheim-Hochstetten (DE)

(21) Appl. No.: 19/018,984

(22) Filed: Jan. 13, 2025

(51) Int. Cl. G06F 11/3668; G06F 8/71; G06F 11/3698

(52) U.S. Cl. CPC G06F 11/3688; G06F 8/71; G06F 11/3698

(57) ABSTRACT

Systems and methods described herein relate to automated control of software development pipeline progression. Examples herein provide for automated validation and progression through multiple sequential stages without manual intervention between states. A user interface of a continuous integration tool receives a user selection of a target state in a software development pipeline. Based on the selected target state, the system automatically progresses an increment through a sequence of states by executing automated tests associated with a current state, detecting when a current state precedes the target state, and automatically transitioning to a next state after successful completion of the automated tests if the current state precedes the target state. In some examples, the automated progression repeats until the current state reaches the target state, with results data presented via the user interface indicating at least the current state and the successful completion of the automated tests.

### TECHNICAL FIELD

The subject matter disclosed herein generally relates to software development systems. More specifically, but not exclusively, the subject matter relates to computer-implemented control of pipeline progression in software development systems.

### BACKGROUND

Software development pipelines have become increasingly complex, with many implementations relying on multiple validation stages to ensure satisfactory performance, code quality, and system stability. A software development pipeline can involve various verification steps, such as unit testing, integration testing, and qualification processes.

The growing scale of enterprise software development, for example, has led to high volumes of code changes being processed through such multi-stage pipelines. Software tools, such as continuous integration (CI) tools, can help to manage software development pipelines by providing interfaces for triggering tests, tracking and adjusting statuses of changes (e.g., corrections or new features), checking errors and feedback, and coordinating other aspects of integration or deployment. While tools of this nature can facilitate the overall pipeline process, the increasing complexity and scale of software development projects make it technically challenging to maintain efficient development workflows while ensuring proper testing and validation of all changes.

### BRIEF DESCRIPTION OF THE DRAWINGS

Some examples are shown for purposes of illustration and not limitation in the figures of the accompanying drawings. In the drawings, which are not necessarily drawn to scale, like numerals may describe similar components in different views or examples. To identify the discussion of any particular element or act more easily, the most significant digit or digits in a reference number refer to the figure number in which that element is first introduced.

FIG. 1 is a diagrammatic representation of a network environment that includes a testing and validation system and a CI tool to facilitate a software development process, according to some examples.

FIG. 2 is a block diagram of components of a CI tool, according to some examples.

FIG. 3 provides a diagrammatic representation of a software development pipeline, and further illustrates automated progression between certain states in the software development pipeline, according to some examples.

FIG. 4 is a flowchart illustrating operations of a method for automated control of software development pipeline progression, according to some examples.

FIG. 5 is a user interface diagram illustrating a CI tool interface, according to some examples.

FIG. 6 is a user interface diagram illustrating a CI tool interface, according to some examples.

FIG. 7 is a block diagram showing a software architecture for a computing device, according to some examples.

FIG. 8 is a block diagram of a machine in the form of a computer system, according to some examples, within which instructions may be executed for causing the machine to perform one or more of the methodologies discussed herein.

### DETAILED DESCRIPTION

A “software development pipeline,” as used herein, may include a sequence of states through which development artifacts progress during a development process. In some cases, each state in the software development pipeline is associated with a defined stage or step in the process of building, testing, integrating, or deploying software. The software development pipeline may support multiple concurrent progression paths where different artifacts can progress independently.

An “increment,” as used herein, may include a discrete unit of software development changes, corrections, updates, or additions that progresses through defined states of a software development pipeline. An increment may include one or more code changes, corrections, updates, or additions, test cases, documentation updates, or other development artifacts that are processed together as a cohesive unit through the software development pipeline. An increment may be classified into different types, such as a correction increment for addressing bugs, hotfixes, or relatively small cleanups or changes (e.g., refactorings), or a feature increment for introducing new or adjusted functionality. In this context, “corrections” and “features” are non-limiting examples. Increments can be classified into various other types, classes, or categories. Examples of other defined types include “cleanup,” “technical enhancement,” “modernization,” or “legal change.” In some examples, such as in an ABAP (Advanced Business Application Programming) context, an increment may be captured or formatted in the form of a transport (e.g., a container holding changes made to objects).

Different types of increments may have different states or sequences of states in their software development pipelines. For example, a correction increment may progress from development to integration in a main release codebase, while a feature increment may require additional qualification steps or more extensive tests (e.g., traceability checks) before feature integration.

A “CI tool,” as used herein, may include a software application, feature, or tool, or set of software applications, features, or tools, that manages progression of increments through pipeline states. The CI tool may interface with test execution systems, handle error conditions, manage notifications, track progression status, and maintain audit logs of pipeline activities. In some examples, the CI tool may be part of a “continuous integration and continuous delivery” (CI/CD) system that manages both integration and deployment aspects of the software development lifecycle. A CI tool, as used herein, may thus include both integration and delivery features. In some examples, the CI tool automates at least part of an integration process by continuously merging code changes into a shared repository.

A CI tool may support various deployment scenarios and delivery mechanisms, including feature deliveries, main releases, and deployment to different environments. The CI tool may also integrate with and coordinate other development or delivery tools, including external applications, test execution systems, and deployment automation tools, to provide comprehensive pipeline management capabilities.

In conventional CI tools, progression of an increment along the software development pipeline can frequently be characterized as a stop-start process. The process is typically halted at each new state, requiring manual intervention from a user to move the process forward. For example, the CI tool stops the process and waits for an explicit release instruction from the user before transitioning from an initial “in development” state to an “in testing” state, and waits for explicit integration approval from the user (or even multiple levels of user approval) before transitioning from an “in integration qualification” state to an “integrated” state. Multiple system messages and user interactions may thus be needed to move from a current state to the following state, even where no errors or other issues are identified for the current state.

Examples described herein provide a computer system that automates state transitions, with automated validation occurring before progression to subsequent states. A CI tool according to examples in the present disclosure drives state transitions up to a user-defined target state. In this way, CI technology is improved by reducing waiting times, the number of context switches needed to progress through the software development pipeline, and thus the lead-time until an increment is available (e.g., until a correction is available in a main release codeline). In some examples, the CI tool automatically drives the process through to the target state and only stops when an exception occurs.

The system may be configured to receive a user selection of a target state in a software development pipeline via a user interface of a CI tool. Based on the user selection, the system automatically progresses an increment through a sequence of pipeline states by executing automated tests associated with each current state, detecting whether the current state precedes the selected target state, and automatically transitioning the increment to a subsequent state upon successful test completion if the current state precedes the target state. In some examples, for at least one of the states in the sequence, the automated test or tests are triggered automatically in response to detecting that the increment is in that state, and that the state precedes the selected target state.

In some examples, the system checks whether all technical pre-conditions for moving to the next stage (including but not limited to all automated tests) have been met before triggering the automatic transition. In some examples, this automated progression continues until the target state is reached, with results data being presented via the user interface to indicate, for example, the current state (e.g., that the target state has been reached) and successful test completions.

Each state may have one or more predetermined, automated tests to be successfully completed. For example, the automated tests can include unit tests that verify individual components, static tests that analyze code without execution, dynamic tests that evaluate runtime behavior, regression tests that check for unintended side effects, performance tests that measure system responsiveness, or security scans that identify vulnerabilities. The automated tests may be executed by a test execution and validation system working in conjunction with the CI tool to validate increments before allowing progression between pipeline states.

The system may support concurrent progression paths for multiple users and multiple increments. For example, a first user may select a first target state for a first increment while a second user selects a different second target state for a second increment, with the system automatically progressing both increments independently until reaching their respective target states.

The user interface may display multiple user-selectable options associated with respective pipeline states, enabling users to specify their desired target states. The system can detect types of increments, identify applicable pipeline states based on those types, and dynamically generate appropriate user-selectable target state options that apply to the specific increments being processed.

In some examples, for executing automated tests, the system includes error handling capabilities where test execution errors are detected, progression is halted, and error notifications are transmitted to relevant users prior to state transitions. After errors are corrected, the system may resume the automated progression of the increments.

The system may provide comprehensive status tracking by transmitting notifications for each state transition to keep users informed of progression status. In some examples, the system displays corrective actions for users based on test outcomes, with specific corrective action recommendations generated from automated test results. Users may initiate pipeline progression by submitting explicit requests through the user interface, triggering the automated progression process according to their selected target states.

Examples in the present disclosure provide technological solutions to technological problems in the field of software development technology (e.g., CI or CI/CD tools). One technological problem is that existing software development systems require users to manually trigger and monitor each state transition, increasing the practical burden on users and the technical burden on the computing system. For example, users have to interact with the CI tool repeatedly to trigger next steps and the CI tool has to transmit a large number of approval requests and continuously monitor the status of work-in-progress increments awaiting user action through multiple pipeline stages. This configuration introduces delays and bottlenecks into the process. Moreover, it may lead to significant additional system overhead and inefficient utilization of computing resources (e.g., processing resources and memory resources).

The present disclosure solves this technological problem by enabling automated progression of increments through at least some pipeline states by implementing a target state selection component that enables users to specify desired endpoints. In some examples, the system automatically executes state transitions without manual intervention by detecting when current states precede the relevant target state and automatically transitioning increments to subsequent states upon successful test completion. In some cases, users only have to interact with the CI tool (after selecting the target state) to move the process forward prior to the target endpoint if an error is detected. Particularly in computing systems serving a large number of users (e.g., thousands of developers), this technique saves time and significantly reduces the load on the resources of the computing systems (e.g., frees up more processing resources and memory resources).

Another technological problem is that existing software development systems lack an automated mechanism to continuously validate and progress increments through states based on technical pre-conditions being fulfilled. For example, a system cannot determine when all technical pre-conditions are met to advance to the next pipeline state, instead waiting for manual verification even when automated tests are sufficient for validation. Examples described herein address this technological problem by enabling automated control over pipeline state progression. A state transition component may automatically advance increments to the next state only after successful completion of automated tests or other automated pre-checks, providing continuous automated validation.

A further technological problem is that existing software development systems lack the ability to automatically coordinate multiple parallel pipeline progressions across different increments and users, particularly where the increments can be of different types or users can have different desired endpoints. Examples in the present disclosure address this technological problem by efficiently handling multiple different types of increments, multiple different desired endpoints (e.g., target states), or both, across various users of a CI tool. This technical architecture enables efficient coordination of multiple concurrent pipeline processes through automated state management rather than manual orchestration.

By enabling a computing system to perform the operations as described herein, such as automated state transitions, the operation of the computing system is improved. Moreover, by streamlining the pipeline process as described, the computing system can save computing resources, such as processor cycles, network traffic, memory usage, graphics processing unit (GPU) resources, data storage capacity, power consumption, or cooling capacity. For example, a computing system that implements a method of the present disclosure can significantly reduce computational overhead and system resource utilization by eliminating redundant pipeline state checks, transition delays, or interactions. Such a computing system can also more effectively handle increased throughput with less manual involvement.

Moreover, the accuracy and reliability of the computing system is improved through automated validation and state transitions in the manner described in the present disclosure. In some examples, the system can immediately halt progression and notify developers when issues are detected, preventing problematic code from propagating through the pipeline. Examples also provide for audit logging components to maintain detailed technical records of all automated progressions and validations, enabling system verification and compliance tracking. Overall, the present disclosure improves development integration technology by enabling faster increment progression and earlier liberation of locked development resources.

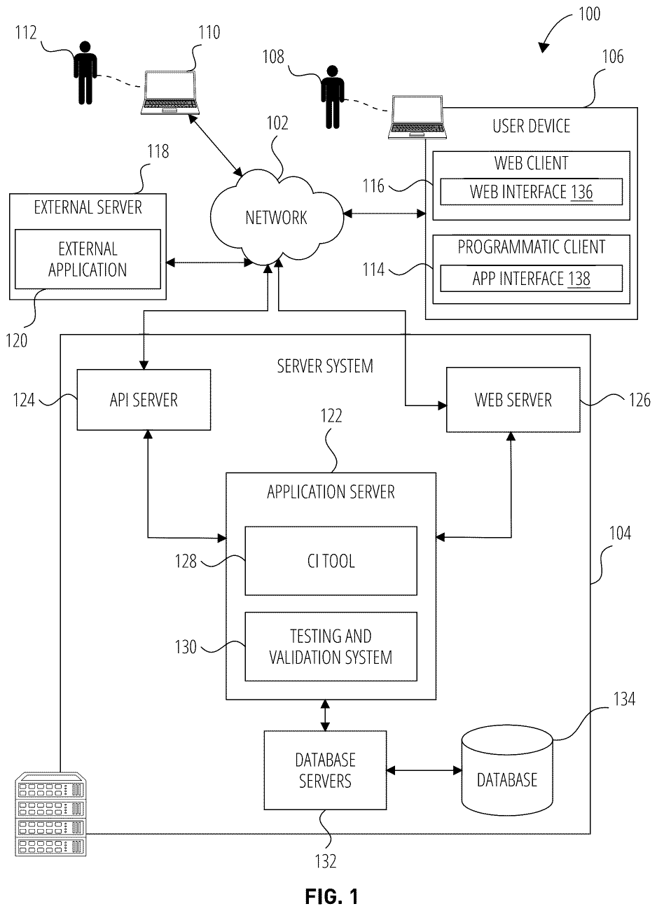

FIG. 1 is a diagrammatic representation of a networked computing environment 100 in which some examples of the present disclosure may be implemented or deployed. One or more servers in a server system 104 provide server-side functionality via a network 102 to a networked device, in the example form of a user device 106 that is accessed by a user 108. A web client 116 (e.g., a browser) or a programmatic client 114 (e.g., an “app”) may be hosted and executed on the user device 106.

An Application Program Interface (API) server 124 and a web server 126 provide respective programmatic and web interfaces to components of the server system 104. An application server 122 hosts a CI tool 128 and a testing and validation system 130, each of which includes one or more components, modules, or applications. In some examples, the CI tool 128 and testing and validation system 130 are hosted on separate application servers or across a set of application servers.

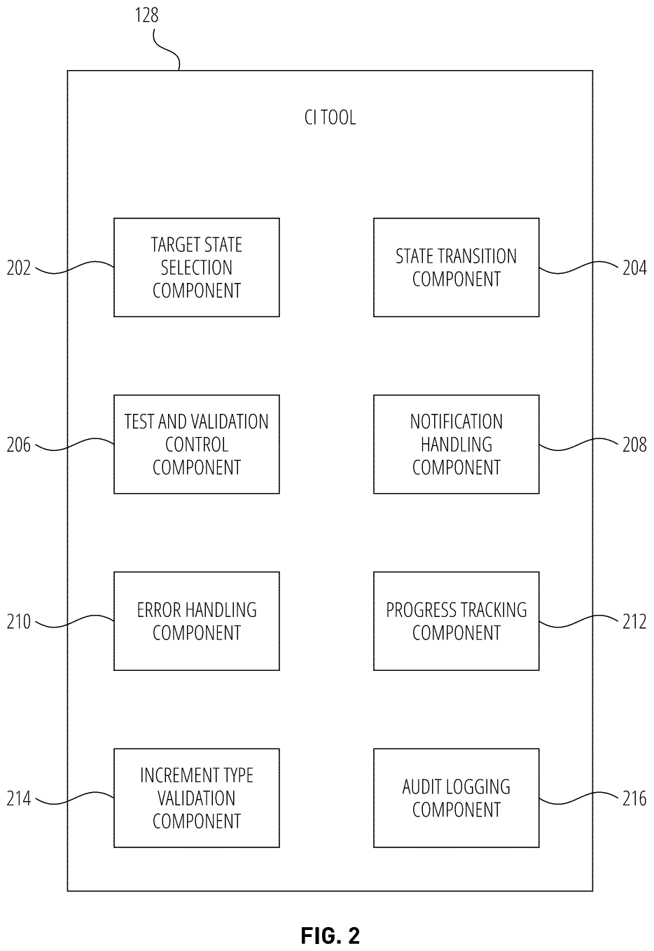

The user device 106 can communicate with the application server 122, e.g., via the web interface supported by the web server 126 or via the programmatic interface provided by the API server 124. The networked computing environment 100 can accommodate multiple users, and FIG. 2 further shows a user device 110 of a user 112. The user device 110 can be similar to the user device 106.

It will be appreciated that, although only the user device 106 and the user device 110 are shown in FIG. 1, and although the user device 106 is primarily referenced below to describe certain examples, a large number of user devices may be communicatively coupled to the server system 104 in some examples. Further, while certain functions may be described herein as being performed at either a user device (e.g., the web client 116 or programmatic client 114 of the user device 106) or the server system 104, the location of certain functionality either within the user device or the server system 104 may be a design choice.

The application server 122 is communicatively coupled to database servers 132, facilitating access to one or more information storage repositories, such as a database 134. In some examples, the database 134 includes storage devices that store information to be processed by the CI tool 128 or the testing and validation system 130.

The application server 122 accesses application data (e.g., application data stored by the database servers 132) to provide one or more applications or software tools to the user device 106 via a web interface 136 or an app interface 138. In some examples, the application server 122, using the CI tool 128 and testing and validation system 130, may provide features that enable users to drive increments through a software development pipeline. The CI tool 128 and the testing and validation system 130 are not shown to provide an exhaustive indication of tools, systems, or sub-systems involved in a software development pipeline. Instead, the CI tool 128 and the testing and validation system 130 are shown to provide a non-limiting illustration of certain aspects of the present disclosure.

The CI tool 128 includes functionality for managing automated progression of increments through a software development pipeline. In some examples, the CI tool 128 is designed to streamline and automate development, testing, and deployment processes for applications within one or various development environments. Depending on the development environment, the CI tool 128 can provide one or more of source control management, automated testing, error handling, increment status management, build automation, deployment automation, monitoring, and reporting. The CI tool 128 can integrate with other development tools and methodologies to enhance efficiency and ensure consistent quality across the software development lifecycle.

In some examples, the CI tool 128 enables automated code integration by continuously merging changes from multiple developers into a shared repository, thereby minimizing integration conflicts and ensuring that the main codebase remains stable. This continuous integration process is complemented by automated testing capabilities, including unit tests and static code checks. These capabilities allow users to validate the functionality, performance, or security of an application, feature, or specific increment.

The CI tool 128 can also support automated build processes, ensuring that applications are consistently compiled and packaged for deployment. Automated build processes may compile integrated code, transforming it into executable artifacts ready for deployment. By automating build processes, the CI tool 128 reduces manual errors and accelerates the delivery of new features and bug fixes. Furthermore, the CI tool 128 may integrate with version control systems, enabling efficient management of code versions and facilitating collaboration among development teams.

In some examples, the CI tool 128 manages the transport of increments across different system landscapes, enabling the networked computing environment 100 to propagate increments from development to production environments. In addition, the CI tool 128 may provide monitoring and reporting features that offer real-time insights into pipeline performance. These insights can allow development teams to identify bottlenecks, track the status of builds and deployments, and ensure that any issues are promptly addressed.

The CI tool 128 supports concurrent processing of multiple increments through parallel progression paths. In some examples, different users (e.g., the user 108 and the user 112) can select different target states for their respective increments, with the CI tool 128 automatically managing independent progression paths while maintaining proper isolation. The CI tool 128 can further detect and manage progression based on increment type to ensure that automated progression is only enabled for appropriate increment types based on configured validation rules. In some examples, the CI tool 128 handles a large amount of increments (e.g., hundreds or even thousands of increments per week).

In some examples, the CI tool 128 provides a user interface (e.g., via the web interface 136 or the app interface 138) that enables users to interact with and control automated progression functionality. In some examples, the user interface displays automated progression options that allow users to select a target state from available pipeline states. The user interface may present integration information and status indicators showing the current state of tests, validations, and other pipeline checks. In some examples, users can view detailed progress information including prerequisites, errors, warnings, and successful completions for each increment. The interface provides options to request progression, view test results, and receive notifications about pipeline status. In some examples, the user interface dynamically adjusts the available target state options based on the increment type and validation rules, ensuring users can only select appropriate progression paths for their specific increment. The interface may also display corrective actions and allow users to analyze and respond to issues encountered during automated progression.

The testing and validation system 130 works in conjunction with the CI tool 128 to perform testing or validation of increments throughout the software development pipeline. In some examples, the testing and validation system 130 executes one or multiple types of automated tests at each pipeline stage. In one specific example, the testing and validation system 130 is responsible for at least some of the following automated tests:
Static or dynamic code checks: the testing and validation system 130 performs automated code analysis checks before one or more state transitions.
Integration conflicts: the testing and validation system 130 checks for potential conflicts with parallel changes from other developers.
Prerequisites and dependencies: the testing and validation system 130 checks whether one or more technical prerequisites or dependencies are satisfied before progression can occur.
Increment validation: for example, where transports are used, the testing and validation system 130 verifies that transport-related requirements are met.
Other issues: the testing and validation system 130 checks for other technical or security issues or warnings that could impact progression.

Accordingly, in the present context, a “test” should be interpreted to include not only code tests such as static or dynamic code tests, but also other checks or validation steps that may be performed before an increment is permitted to progress further along the software development pipeline. In some examples, the testing and validation system 130 maintains test environments and configurations specific to each pipeline stage, enabling proper validation of increments as they progress, for example, from development through integration qualification and into the main release. The testing and validation system 130 may interface with a control component of the CI tool 128 to coordinate test execution and result reporting. In some examples, the testing and validation system 130 performs automated validation checks appropriate for the increment type and current pipeline stage.

The testing and validation system 130 maintains audit logs of the checks and their results throughout the progression process. In some examples, the testing and validation system 130 maintains detailed test results and validation status information in the database 134. This enables the CI tool 128 to track increment progression, generate notifications about test failures, and maintain audit records of all validation activities. The testing and validation system 130 can execute tests in parallel across multiple environments to improve pipeline throughput when processing large numbers of increments concurrently.

In some examples, the application server 122 is part of a cloud-based platform provided by a software provider that allows a user (e.g., the user 108 or the user 112) to develop software and utilize the CI tool 128. The CI tool 128 may receive, access, or retrieve data from various sources, such as internal systems of the server system 104 or external systems.

In some examples, external applications (which may be third-party applications or applications provided by the software provider referred to above), such as an external application 120 executing on an external server 118, can communicate with the application server 122 via the programmatic interface provided by the API server 124. For example, a third-party application may support one or more features or functions on a website or platform hosted by a third party, or may perform certain methodologies and provide input or output information to the application server 122 for further processing or publication.

The network 102 may be any network that enables communication between or among machines, databases, and devices. Accordingly, the network 102 may be a wired network, a wireless network (e.g., a mobile or cellular network), or any suitable combination thereof. The network 102 may include one or more portions that constitute a private network, a public network (e.g., the Internet), or any suitable combination thereof.

FIG. 2 is a block diagram illustrating components of the CI tool 128 of FIG. 1, according to some examples. The CI tool 128 is shown to include a target state selection component 202, a state transition component 204, a test and validation control component 206, a notification handling component 208, an error handling component 210, a progress tracking component 212, an increment type validation component 214, and an audit logging component 216.

The target state selection component 202 may be configured to receive and process user selections of desired pipeline endpoints (e.g., through a CI tool user interface provided via the web interface 136). In some examples, the target state selection component 202 displays multiple user-selectable target state options and enables users to specify states where automated progression should stop. In this context, the “endpoint” refers to the point or state to which the user wishes to have the CI tool 128 automatically drive progression of an increment. The ultimate endpoint of the software development pipeline itself may thus be after the “endpoint” selected by the user. The target state selection component 202 may dynamically generate these options based on the type of increments being processed, allowing selection only from applicable pipeline states.

The state transition component 204 manages the automated progression of increments between pipeline states. In some examples, the state transition component 204 evaluates whether the current state precedes the selected target state for a particular increment and automatically transitions increments to subsequent states when validation criteria are met (e.g., automated tests are successfully completed and/or other predetermined checks are satisfied for the current state). The state transition component 204 may coordinate with other components of the CI tool 128 to ensure proper sequencing of state transitions and maintain isolation between multiple concurrent progression paths.

In some examples, the test and validation control component 206 interfaces with the testing and validation system 130 to perform automated validation at one or various pipeline stages. In some examples, the test and validation control component 206 triggers execution of various types of automated tests, such as unit tests, static tests, dynamic tests, regression tests, performance tests, and security scans. The test and validation control component 206 may coordinate with the state transition component 204 to determine whether validation criteria are satisfied before allowing progression to subsequent states. In some examples, when validation fails, the test and validation control component 206 works with the error handling component 210 to halt progression and notify developers.

The notification handling component 208 may manage communications between the CI tool 128 and users regarding pipeline progression status. In some examples, the notification handling component 208 transmits notifications to user devices indicating state transitions, test completion status, and error conditions. The notification handling component 208 may generate and send different types of notifications based on pipeline events, including successful state transitions, test failures, or when target states are reached.

The error handling component 210 may detect and process issues that arise during pipeline progression. In some examples, when automated tests fail or other errors occur, the error handling component 210 halts the progression of increments, coordinates with the notification handling component 208 to alert users, and maintains the halted state until issues are resolved. The error handling component 210 may also manage the process of resuming progression after errors are corrected. In some cases, the user may provide an instruction to resume progression at the current state (e.g., the state in which the error was detected) or to return to an earlier pipeline state (e.g., to return to an initial state so that all tests can be repeated). In the latter case, the error handling component 210 may communicate with the state transition component 204 to transition the increment to the appropriate earlier (e.g., initial) state.

The progress tracking component 212 may monitor and record the status of increments as they move through pipeline states. In some examples, the progress tracking component 212 maintains information about current states, completed transitions, and remaining steps needed to reach target states. The progress tracking component 212 may work with other components to ensure proper sequencing of state transitions and maintain isolation between multiple concurrent progression paths.

The increment type validation component 214 may verify that increments are properly classified and eligible for automated progression. In some examples, the increment type validation component 214 validates or determines whether increments are corrections, feature increments, or other supported types. The increment type validation component 214 may work with the target state selection component 202 to dynamically generate appropriate progression options based on the validated increment type.

In some examples, the increment type validation component 214 validates whether a particular increment type is permitted to use automated progression features prior to triggering any automated progression features for a user's increment. For example, the database 134 may include a listing of feature types for which automated progression is enabled (e.g., enabled for correction increments that only need automated tests) and for which automated progression is disabled (e.g., disabled for feature increments that need automated and manual testing). For instance, the increment type validation component 214 may compare a label or identifier of an increment against the relevant data (e.g., database listing or stored rules) and only enable automated progression where permitted.

In some examples, the increment type validation component 214 may analyze an increment and generate a suitable type identifier for the increment (e.g., where the user does not label, or incorrectly labels, the increment). For example, the increment type validation component 214 can execute a trained machine learning model that checks the content or format of the increment and outputs a predicted type or class. This allows the CI tool 128 to enable the appropriate features for the type of increment it is handling. In this way, the reliability or robustness of the CI tool 128 can be further improved.

The audit logging component 216 may maintain detailed records of increment progression through the software development pipeline. In some examples, the audit logging component 216 generates and stores information at one or more pipeline stages to document the validation and progression of increments. The audit logging component 216 may track information about increment types, user selections of target states, test results, state transitions, and other pipeline events to support internal and external auditing requirements. In some examples, the audit logging component 216 works with the database 134 to store audit records in an audit-proof directory that can be used to demonstrate compliance with quality standards. The audit logging component 216 may coordinate with other components such as the progress tracking component 212 and test and validation control component 206 for comprehensive logging of automated progression activities and their outcomes.

In some examples, at least some of the components shown in FIG. 2 are configured to communicate with each other to implement aspects described herein. One or more of the components described herein may be implemented using hardware (e.g., one or more processors of one or more machines) or a combination of hardware and software. For example, a component described herein may be implemented by a processor configured to perform the operations described herein for that component. Moreover, two or more of these components may be combined into a single component, or the functions described herein for a single component may be subdivided among multiple components. Furthermore, according to various examples, components described herein may be implemented using a single machine, database, or device, or be distributed across multiple machines, databases, or devices.

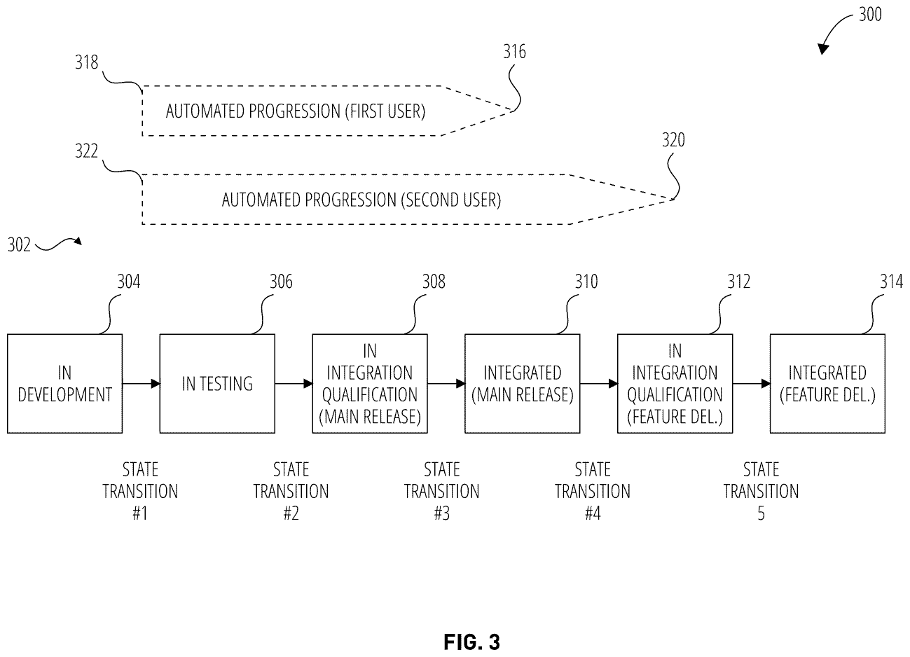

FIG. 3 is diagram 300 showing a software development pipeline 302, according to some examples. FIG. 3 further illustrates automated progression between certain states in the software development pipeline 302, according to some examples. The software development pipeline 302 may be controlled using the CI tool 128 and the testing and validation system 130 of FIG. 1 and FIG. 2.

The software development pipeline 302 includes a plurality of states, or stages. In FIG. 3, the software development pipeline 302 is shown to include a first state 304, a second state 306, a third state 308, a fourth state 310, a fifth state 312, and a sixth state 314, respectively called “in development,” “in testing,” “in integration qualification (main release),” “integrated (main release),” “in integration qualification (feature delivery),” and “integrated (feature delivery).” A state transition occurs to move an increment (e.g., a correction, change, or feature) in the software development pipeline 302 from one state to the next. The specific sequence of states in FIG. 3 is merely provided as a non-limiting example and it will be appreciated that a software development pipeline may include various states and different sequences of states, depending on various factors, such as the development ecosystem, pipeline requirements, or operator preferences.

As discussed elsewhere in the present disclosure, in conventional CI tools, significant time and computing resources may be expended on state transitions. For example, a user starts the process by developing an increment and then releases the increment (e.g., releases a transport) to trigger state transition #1. The process halts and waits for the user to manually request integration before triggering state transition #2. The process halts again and waits for the user to manually approve integration before triggering state transition #3. The process then halts again. Where feature delivery is involved, as shown in FIG. 3, the process waits for the user to manually request integration before triggering state transition #4. The process then halts once more and waits for the user to manually approve integration before triggering state transition #5. Thus, even where no errors are detected or where no corrective measures are needed, each state transition may still involve multiple system messages (e.g., emails transmitted by the CI tool to different levels of users) and multiple user interactions (e.g., multiple levels of user review or approval).

Examples in the present disclosure automate one or multiple state transitions by enabling desired target state selection. In some examples, each of a plurality of users can select a desired target state along the software development pipeline 302. For each user, the CI tool 128 drives an increment through the process up to the target state, unless an error to be addressed by the user is detected before reaching the target state.

For example, a first user (e.g., the user 108 of FIG. 1) selects a target endpoint 316 corresponding to the fourth state 310 along the software development pipeline 302 for an increment in the CI tool 128. Once the first user has triggered the process (e.g., by releasing the increment into the second state 306), the CI tool 128 then drives automated progression 318 of the increment until the target endpoint 316 is reached. In this example, the first user wishes for their increment to be automatically processed (e.g., including automatic execution of all automated tests needed for each state) until the increment is integrated into main release.

As another example, a second user (e.g., the user 112 of FIG. 1) selects a target endpoint 320 corresponding to the fifth state 312 along the software development pipeline 302 for an increment in the CI tool 128. Once the second user has triggered the process, the CI tool 128 then drives automated progression 322 up to the target endpoint 320, subject to errors being detected before the CI tool 128 reaches the target endpoint 320, where such errors are reportable to the user prior to further progression.

Thus, the CI tool 128 may progress increments through different sequences of states based on user-selected target endpoints. In some examples, the CI tool 128 is responsible for automatically testing and validating the increment for each state associated with an automated transition (e.g., transitions #2 and #3 for the first user). As a result, the CI tool 128 automatically executes tests and verifications at each relevant transition point to ensure increments meet the required criteria before advancing. The CI tool 128 may also automatically test and validate the increment as required in the state corresponding to the endpoint itself (e.g., the fourth state 310 for the first user).

In some examples, the CI tool 128 transmits, to a user device of a user (e.g., the user device 106 of the user 108), a notification related to each state, each automated transition, or both. For example, the CI tool 128 can notify the user 108 (e.g., via an automated email, or via the web client 116 or programmatic client 114) that their increment has been successfully transitioned to integration qualification, and then subsequently notify the user 108 that their increment has been successfully integrated into main release, with no user intervention needed.

Where errors arise, the CI tool 128 may halt the process and notify the user. In some examples, the user is enabled, in response to an error that causes the process to be stopped, to adjust the state so as to move the increment back to an earlier state (e.g., “in development”). The user can then address the error and restart the automated pipeline progression. Other errors may be addressable without necessitating a state adjustment.

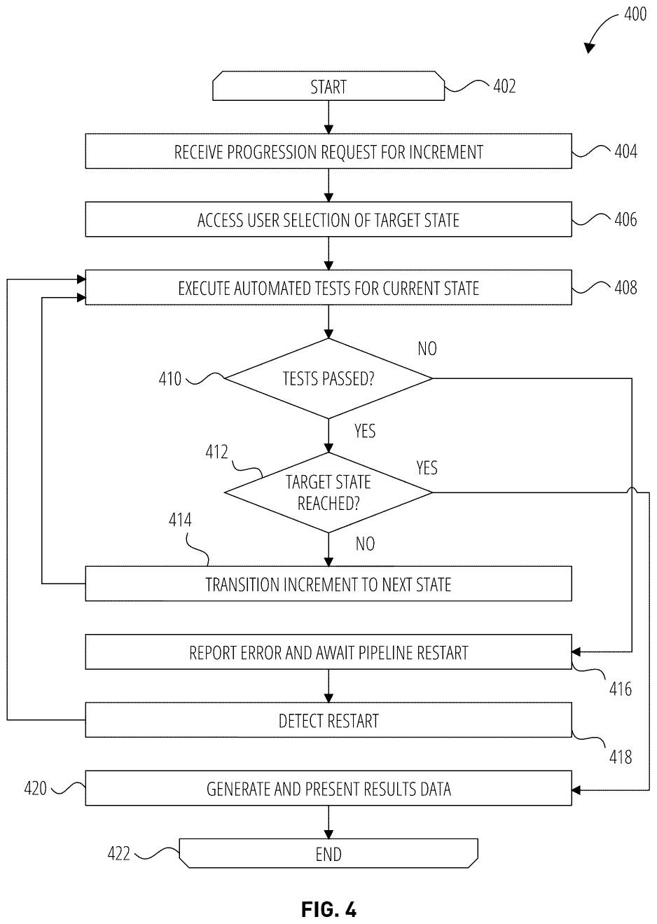

FIG. 4 is a flowchart illustrating operations of a method 400 for automated control of software development pipeline progression, according to some examples. By way of example and not limitation, aspects of the method 400 may be performed by the components, systems, or elements shown in FIG. 1 and FIG. 2.

The method 400 commences at opening loop operation 402 and proceeds to operation 404, where the CI tool 128 of FIG. 1 receives a progression request for an increment. For example, the increment is an increment developed by the user 108 of the user device 106 of the user 108, and the user 108 wishes to have the increment integrated into a main release associated with a software application.

The CI tool 128 receives the progression request from the user device 106 of the user 108 of FIG. 1. For example, the user 108 submits the progression request via the web interface 136.

At operation 406, the CI tool 128 accesses a user selection of a target state (e.g., desired endpoint). The user selection of the target state may be incorporated in the progression request or can be a separately provided selection.

The CI tool 128 then proceeds to automatically drive progression of the increment. At operation 408, the CI tool 128 causes execution (e.g., via the testing and validation system 130 of FIG. 1) of one or more automated tests designated for the current state in which the increment is found. In some examples, the CI tool 128 checks whether the current state precedes the target state before triggering test execution.

Various tests may be performed, depending on the environment and implementation. For example, the tests can include unit tests, static tests, dynamic tests, regression tests, performance tests, or security scans. In this context, “tests” can also include other “pre-checks” to be passed before an increment can progress along its software development pipeline. Such pre-checks can include quality checks, type validation (e.g., the CI tool 128 validates whether the increment is properly classified as a correction versus a feature, and whether progression is allowed on this basis), status checks, conflict detection, or dependency checks.

As illustrated by decision operation 410, the CI tool 128 checks on the outcome of all relevant tests for the current state, and if no issues are found, the CI tool 128 proceeds without reporting any errors. The CI tool 128 compares the current state with the target state at decision operation 412.

If the target state has not been reached (e.g., the current state precedes the target state in the relevant sequence of states of the pipeline), the CI tool 128 automatically transitions the increment to the next state in the sequence at operation 414 without user interaction to validate or confirm the transition. As mentioned above, while not shown in FIG. 4, in some examples, test execution is only triggered once the CI tool 128 detects that the current state precedes the target state. The method 400 then proceeds to operation 408 again where the CI tool 128 handles the next state (e.g., the “new current state”).

If the CI tool 128 detects, at decision operation 412, that the target state has been reached (e.g., the current state equals the target state), the CI tool 128 does not perform further automated state transitions. Instead, the CI tool 128 may generate and present results data as shown at operation 420. The results data can include, for example, an indication of at least the current state (e.g., to confirm that the target state has been reached) and the successful completion of the one or more automated tests (this may include tests executed by the testing and validation system 130 for various states or stages). For example, the results data can indicate that “increment was successfully integrated into the main release” with a summary of tests and validations performed by the CI tool 128.

These tests act as automated quality, stability, or performance gates—if a test fails, the automated progression is halted and the user 108 is notified to address the issue or issues before progression can continue. This is also illustrated by decision operation 410, where the CI tool 128 checks on the outcome of all relevant tests, and if it finds that one or more were unsuccessful or reported an error, the CI tool 128 sends an error notification to the user 108 and awaits a pipeline restart (operation 416). At operation 418, the CI tool 128 detects a restart (e.g., the user 108 fixed the error and opted to restart the pipeline) and proceeds back to operation 408.

The method 400 concludes at closing loop operation 422. While the aforementioned description focuses on the progression of a single increment through a particular pipeline and for a particular target state, it is noted that the method 400 may support concurrent progression paths where different users can select different target states for their respective increments. For example, the increment type validation component 214 can validate increment types to determine appropriate progression paths. In some examples, the audit logging component 216 maintains records of all automated progressions and validations throughout the process.

In some examples, the CI tool 128 runs a process that continuously checks (e.g., using the state transition component 204) for any increments that are not yet in their respective target states. For each identified increment, the CI tool 128 then checks whether the necessary automated tests, or pre-checks, have been completed. If they have been completed successfully, the CI tool 128 executes the transition. If they have not been completed successfully, the CI tool 128 may trigger an attempt to execute the necessary automated tests or pre-checks (e.g., via the testing and validation system 130) and then execute the transition, if possible. In this way, the CI tool 128 continuously drives movement along the pipeline for the relevant increments, reducing lead times and improving overall system efficiency.

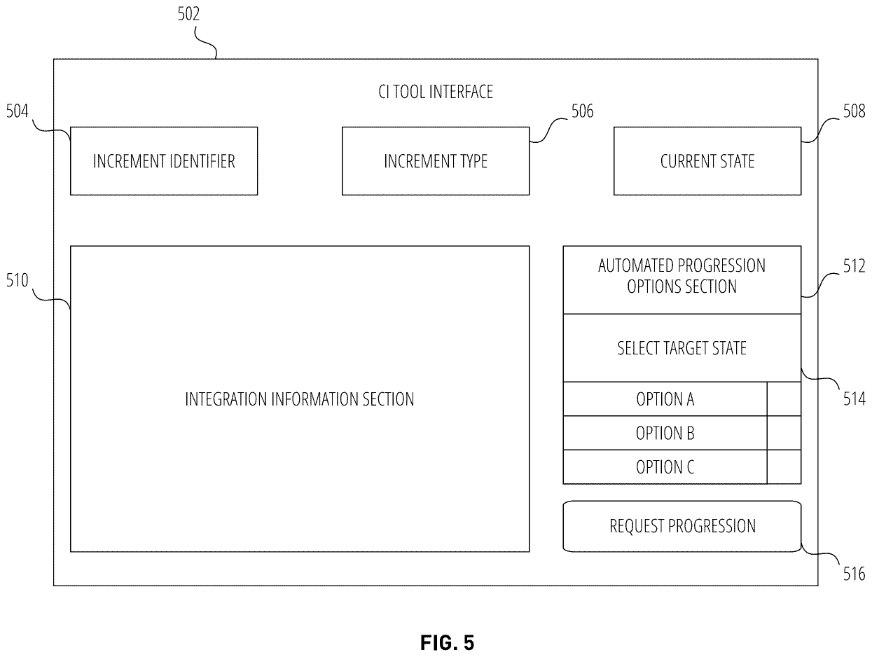

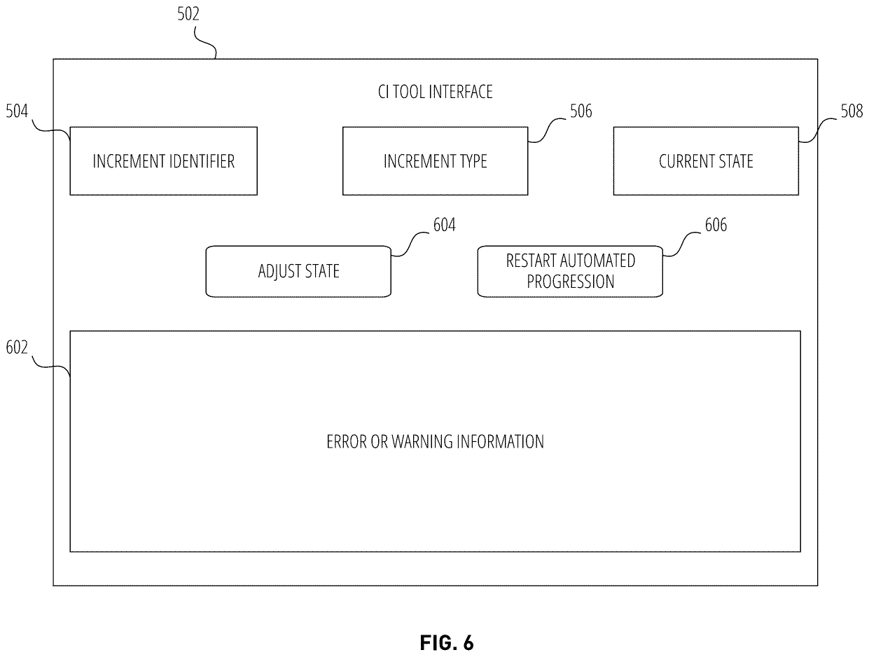

FIG. 5 and FIG. 6 are user interface diagrams illustrating a CI tool interface 502, according to some examples. The CI tool interface 502 can be presented to a user on a user device. For example, the CI tool interface 502 can be provided by the web interface 136 or the app interface 138 of FIG. 1 on the user device 106 or the user device 110.

The CI tool interface 502 provides functionality for managing automated progression of increments, and includes multiple sections for controlling and monitoring pipeline progression. As shown in FIG. 5, the CI tool interface 502 presents an increment identifier 504 and an increment type 506. For example, the CI tool interface 502 can display a name of the relevant increment as well as its type (e.g., correction, feature, or another type that is supported for system-wide use). The CI tool interface 502 further presents a current state 508 of the increment, informing the user of the current position of the increment along the relevant software development pipeline.

An integration information section 510 displays details about the current integration status and progression path. For example, the integration information section 510 provides context about where increments are in the pipeline process and what validations or checks may be required (e.g., more detail about the current state, next action items, or previously detected issues).

An automated progression options section 512 provides controls for specifying how increments should progress through pipeline states. In some examples, and as shown in FIG. 5, the automated progression options section 512 includes a target state selector 514 that enables the user to select desired endpoints for automated progression.

The selector may present multiple options (indicated as Option A, Option B, and Option C in FIG. 5) representing different possible target states in the pipeline. In some examples, the options presented in the CI tool interface 502 are determined by the type of increment. Moreover, automated progression options are, in some examples, only presented for supported increment types.

A request button 516 allows users to initiate the automated progression process after selecting a target state. When activated, this triggers the CI tool (e.g., the CI tool 128) to begin automatically progressing the increment through pipeline states until reaching the specified target, executing validations at each stage.

As discussed elsewhere in the present disclosure, the CI tool 128 may halt pipeline progression in response to an error. FIG. 6 shows the CI tool interface 502 after such an error has been detected. As shown in FIG. 6, in addition to the increment identifier 504, increment type 506, and current state 508, the CI tool interface 502 presents error or warning information 602 to enable the user to understand and correct the relevant issue.

The CI tool interface 502 of FIG. 6 also presents an adjust button 604 that enables the user to adjust the state (e.g., to move back to an initial “in development” state for addressing issues). The CI tool interface 502 further presents a restart button 606 that enables the user to restart the automated progression function, based on the previously selected target state.

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.
Example 1 is a system comprising: at least one memory that stores instructions; and one or more processors configured by the instructions to perform operations comprising: receiving, via a user interface of a continuous integration tool, a user selection of a target state in a software development pipeline; automatically progressing an increment through a sequence of states of the software development pipeline by: detecting that a current state of the increment precedes the target state in the sequence of states, executing one or more automated tests associated with the current state of the increment in the software development pipeline, and after successful completion of the one or more automated tests and based on detecting that the current state precedes the target state, automatically transitioning the increment to a next state in the sequence of states; automatically repeating the progressing of the increment until the target state becomes the current state; and causing presentation, via the user interface, of results data indicating at least the current state and the successful completion of the one or more automated tests.
In Example 2, the subject matter of Example 1 includes, wherein the user selection of the target state is a first user selection of a first target state in the software development pipeline, the first user selection is received from a first user device of a first user of the continuous integration tool, and the increment is a first increment, the operations comprising: receiving, via the user interface and from a second user device of a second user of the continuous integration tool, a second user selection of a second target state in the software development pipeline for a second increment, the second target state differing from the first target state; and automatically progressing both the first increment and the second increment at least partially through the sequence of states, the first increment automatically transitioned until reaching the first target state and the second increment automatically transitioned until reaching the second target state.
In Example 3, the subject matter of any of Examples 1-2 includes, the operations further comprising: displaying a plurality of user-selectable options at a user device of a user of the continuous integration tool, the plurality of user-selectable options being displayed via the user interface and associated with respective states in the software development pipeline, wherein the user selection of the target state comprises a selection of one of the plurality of user-selectable options.
In Example 4, the subject matter of Example 3 includes, the operations further comprising: detecting a type of the increment; identifying the respective states in the software development pipeline that apply to the increment based on the type; and dynamically generating the plurality of user-selectable options to enable the user to select the target state only from among the respective states that apply to the increment.
In Example 5, the subject matter of Example 4 includes, wherein the type of the increment is one of a plurality of different types supported by the continuous integration tool, the plurality of different types comprising at least one of a correction increment or a feature increment.
In Example 6, the subject matter of any of Examples 1-5 includes, the operations further comprising: triggering the executing of the one or more automated tests associated with the current state in response to detecting that the current state of the increment precedes the target state in the sequence of states.
In Example 7, the subject matter of any of Examples 1-6 includes, the operations further comprising: detecting an error resulting from the executing of the one or more automated tests; and in response to detecting the error: halting the progressing of the increment, and transmitting an error notification to a user device of a user of the continuous integration tool prior to the transitioning of the increment to the next state in the sequence of states.
In Example 8, the subject matter of any of Examples 1-7 includes, the operations further comprising: for each transition in the sequence of states, transmitting, to a user device of a user of the continuous integration tool, a notification indicative of the transitioning of the increment to the next state.
In Example 9, the subject matter of any of Examples 1-8 includes, wherein the states of the software development pipeline comprise at least one of a testing state, an integration qualification state, or an integrated state.
In Example 10, the subject matter of any of Examples 1-9 includes, wherein the increment comprises a correction to be integrated into a codeline for release.
In Example 11, the subject matter of any of Examples 1-10 includes, wherein the one or more automated tests comprise at least one of: a unit test, a static test, a dynamic test, a regression test, a performance test, or a security scan.
In Example 12, the subject matter of any of Examples 1 -11 includes, the operations further comprising: displaying, via the user interface, one or more corrective actions to be taken by a user of the continuous integration tool with respect to the increment.
In Example 13, the subject matter of Example 12 includes, the operations further comprising: generating the one or more corrective actions based on an outcome of the one or more automated tests.
In Example 14, the subject matter of any of Examples 1-13 includes, the operations further comprising: receiving, via the user interface and from a user device of a user of the continuous integration tool, a request to progress the software development pipeline for the increment to the target state; and in response to receiving the request and based on the user selection of the target state, triggering the progressing of the increment.
Example 15 is a computer-implemented method performed by a computer system comprising a memory and at least one hardware processor, the computer-implemented method comprising: receiving, via a user interface of a continuous integration tool, a user selection of a target state in a software development pipeline; automatically progressing an increment through a sequence of states of the software development pipeline by: detecting that a current state of the increment precedes the target state in the sequence of states, executing one or more automated tests associated with the current state of the increment in the software development pipeline, and after successful completion of the one or more automated tests and based on detecting that the current state precedes the target state, automatically transitioning the increment to a next state in the sequence of states; automatically repeating the progressing of the increment until the target state becomes the current state; and causing presentation, via the user interface, of results data indicating at least the current state and the successful completion of the one or more automated tests.
In Example 16, the subject matter of Example 15 includes, wherein the user selection of the target state is a first user selection of a first target state in the software development pipeline, the first user selection is received from a first user device of a first user of the continuous integration tool, and the increment is a first increment, the method comprising: receiving, via the user interface and from a second user device of a second user of the continuous integration tool, a second user selection of a second target state in the software development pipeline for a second increment, the second target state differing from the first target state; and automatically progressing both the first increment and the second increment at least partially through the sequence of states, the first increment automatically transitioned until reaching the first target state and the second increment automatically transitioned until reaching the second target state.
In Example 17, the subject matter of any of Examples 15-16 includes, displaying a plurality of user-selectable options at a user device of a user of the continuous integration tool, the plurality of user-selectable options being displayed via the user interface and associated with respective states in the software development pipeline, wherein the user selection of the target state comprises a selection of one of the plurality of user-selectable options.
Example 18 is one or more non-transitory computer-readable media storing computer-executable instructions that, when executed by a computing system, cause the computing system to perform operations comprising: receiving, via a user interface of a continuous integration tool, a user selection of a target state in a software development pipeline; automatically progressing an increment through a sequence of states of the software development pipeline by: detecting that a current state of the increment precedes the target state in the sequence of states, executing one or more automated tests associated with the current state of the increment in the software development pipeline, and after successful completion of the one or more automated tests and based on detecting that the current state precedes the target state, automatically transitioning the increment to a next state in the sequence of states; automatically repeating the progressing of the increment until the target state becomes the current state; and causing presentation, via the user interface, of results data indicating at least the current state and the successful completion of the one or more automated tests.
In Example 19, the subject matter of Example 18 includes, wherein the user selection of the target state is a first user selection of a first target state in the software development pipeline, the first user selection is received from a first user device of a first user of the continuous integration tool, and the increment is a first increment, the operations comprising: receiving, via the user interface and from a second user device of a second user of the continuous integration tool, a second user selection of a second target state in the software development pipeline for a second increment, the second target state differing from the first target state; and automatically progressing both the first increment and the second increment at least partially through the sequence of states, the first increment automatically transitioned until reaching the first target state and the second increment automatically transitioned until reaching the second target state.
In Example 20, the subject matter of any of Examples 18-19 includes, the operations further comprising: displaying a plurality of user-selectable options at a user device of a user of the continuous integration tool, the plurality of user-selectable options being displayed via the user interface and associated with respective states in the software development pipeline, wherein the user selection of the target state comprises a selection of one of the plurality of user-selectable options.
Example 21 is at least one machine-readable medium including instructions that, when executed by processing circuitry, cause the processing circuitry to perform operations to implement any of Examples 1-20.
Example 22 is an apparatus comprising means to implement any of Examples 1-20.
Example 23 is a system to implement any of Examples 1-20.
Example 24 is a method to implement any of Examples 1-20.

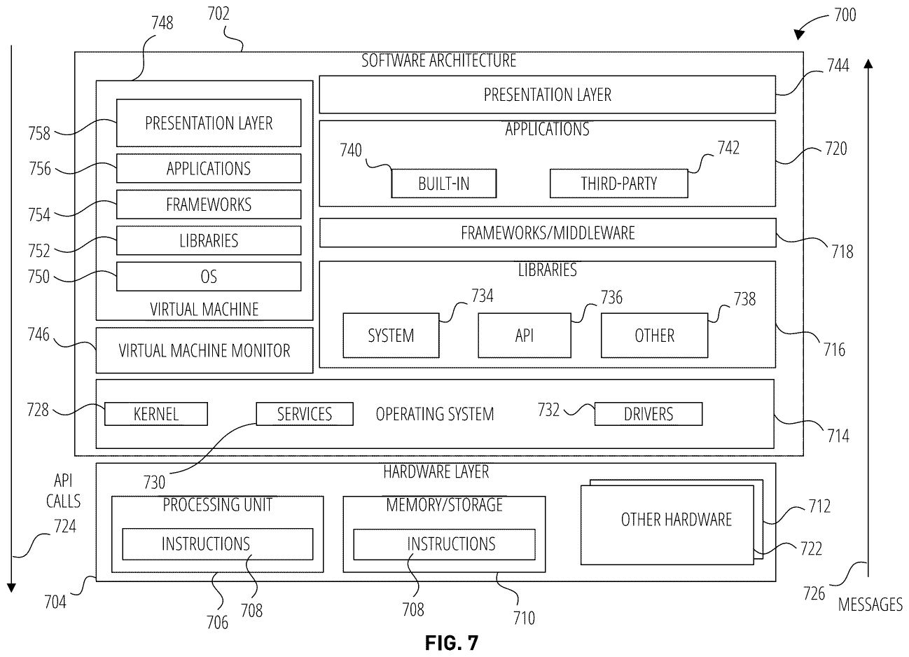

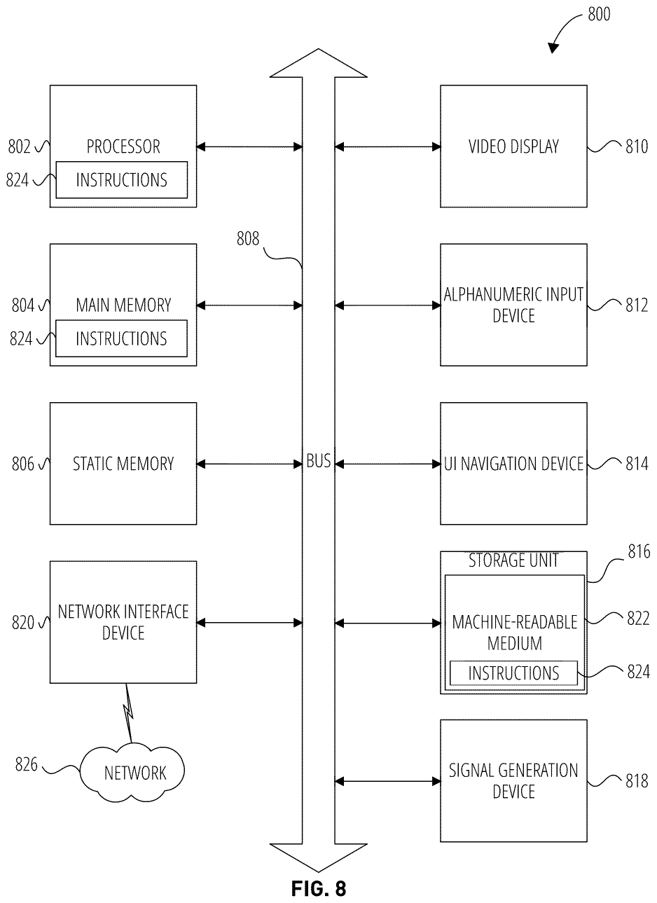

FIG. 7 is a block diagram 700 showing a software architecture 702 for a computing device, according to some examples. The software architecture 702 may be used in conjunction with various hardware architectures, for example, as described herein. FIG. 7 is merely a non-limiting illustration of a software architecture, and many other architectures may be implemented to facilitate the functionality described herein. A representative hardware layer 704 is illustrated and can represent, for example, any of the above referenced computing devices. In some examples, the hardware layer 704 may be implemented according to the architecture of the computer system of FIG. 8.

The representative hardware layer 704 comprises one or more processing units 706 having associated executable instructions 708. Executable instructions 708 represent the executable instructions of the software architecture 702, including implementation of the methods, modules, subsystems, and components, and so forth described herein and may also include memory and/or storage modules 710, which also have executable instructions 708. Hardware layer 704 may also comprise other hardware as indicated by other hardware 712 and other hardware 722 which represent any other hardware of the hardware layer 704, such as the other hardware illustrated as part of the software architecture 702.

In the architecture of FIG. 7, the software architecture 702 may be conceptualized as a stack of layers where each layer provides particular functionality. For example, the software architecture 702 may include layers such as an operating system 714, libraries 716, frameworks/middleware layer 718, applications 720, and presentation layer 744. Operationally, the applications 720 or other components within the layers may invoke API calls 724 through the software stack and access a response, returned values, and so forth illustrated as messages 726 in response to the API calls 724. The layers illustrated are representative in nature and not all software architectures have all layers. For example, some mobile or special purpose operating systems may not provide a frameworks/middleware layer 718, while others may provide such a layer. Other software architectures may include additional or different layers.

The operating system 714 may manage hardware resources and provide common services. The operating system 714 may include, for example, a kernel 728, services 730, and drivers 732. The kernel 728 may act as an abstraction layer between the hardware and the other software layers. For example, the kernel 728 may be responsible for memory management, processor management (e.g., scheduling), component management, networking, security settings, and so on. The services 730 may provide other common services for the other software layers. In some examples, the services 730 include an interrupt service. The interrupt service may detect the receipt of an interrupt and, in response, cause the software architecture 702 to pause its current processing and execute an interrupt service routine (ISR) when an interrupt is accessed.

The drivers 732 may be responsible for controlling or interfacing with the underlying hardware. For instance, the drivers 732 may include display drivers, camera drivers, Bluetooth® drivers, flash memory drivers, serial communication drivers (e.g., Universal Serial Bus (USB) drivers), Wi-Fi® drivers, near-field communication (NFC) drivers, audio drivers, power management drivers, and so forth depending on the hardware configuration.

The libraries 716 may provide a common infrastructure that may be utilized by the applications 720 or other components or layers. The libraries 716 typically provide functionality that allows other software modules to perform tasks in an easier fashion than to interface directly with the underlying operating system 714 functionality (e.g., kernel 728, services 730 or drivers 732). The libraries 716 may include system libraries 734 (e.g., C standard library) that may provide functions such as memory allocation functions, string manipulation functions, mathematic functions, and the like. In addition, the libraries 716 may include API libraries 736 such as media libraries (e.g., libraries to support presentation and manipulation of various media format such as MPEG4, H.264, MP3, AAC, AMR, JPG, PNG), graphics libraries (e.g., an OpenGL framework that may be used to render two-dimensional and three-dimensional in a graphic content on a display), database libraries (e.g., SQLite that may provide various relational database functions), web libraries (e.g., WebKit that may provide web browsing functionality), and the like. The libraries 716 may also include a wide variety of other libraries 738 to provide many other APIs to the applications 720 and other software components/modules.

The frameworks/middleware layer 718 may provide a higher-level common infrastructure that may be utilized by the applications 720 or other software components/modules. For example, the frameworks/middleware layer 718 may provide various graphic user interface (GUI) functions, high-level resource management, high-level location services, and so forth. The frameworks/middleware layer 718 may provide a broad spectrum of other APIs that may be utilized by the applications 720 or other software components/modules, some of which may be specific to a particular operating system or platform.

The applications 720 include built-in applications 740 or third-party applications 742. Examples of representative built-in applications 740 may include, but are not limited to, a contacts application, a browser application, a book reader application, a location application, a media application, a messaging application, or a game application. Third-party applications 742 may include any of the built-in applications as well as a broad assortment of other applications. In a specific example, the third-party application 742 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third-party application 742 may invoke the API calls 724 provided by the mobile operating system such as operating system 714 to facilitate functionality described herein.

The applications 720 may utilize built in operating system functions (e.g., kernel 728, services 730 or drivers 732), libraries (e.g., system libraries 734, API libraries 736, and other libraries 738), and frameworks/middleware layer 718 to create user interfaces to interact with users of the system. Alternatively, or additionally, in some systems, interactions with a user may occur through a presentation layer, such as presentation layer 744. In these systems, the application/module “logic” can be separated from the aspects of the application/module that interact with a user.

Some software architectures utilize virtual machines. In the example of FIG. 7, this is illustrated by virtual machine 748. A virtual machine creates a software environment where applications/modules can execute as if they were executing on a hardware computing device. A virtual machine is hosted by a host operating system (operating system 714) and typically, although not always, has a virtual machine monitor 746, which manages the operation of the virtual machine as well as the interface with the host operating system (e.g., operating system 714). A software architecture executes within the virtual machine 748 such as an operating system 750, libraries 752, frameworks/middleware 754, applications 756 or presentation layer 758. These layers of software architecture executing within the virtual machine 748 can be the same as corresponding layers previously described or may be different.

Certain examples are described herein as including logic or a number of components, modules, or mechanisms. Modules or components may constitute either software modules/components (e.g., code embodied (1) on a non-transitory machine-readable medium or (2) in a transmission signal) or hardware-implemented modules/components. A hardware-implemented module/component is a tangible unit capable of performing certain operations and may be configured or arranged in a certain manner. In examples, one or more computer systems (e.g., a standalone, client, or server computer system) or one or more hardware processors may be configured by software (e.g., an application or application portion) as a hardware-implemented module/component that operates to perform certain operations as described herein.

In various examples, a hardware-implemented module/component may be implemented mechanically or electronically. For example, a hardware-implemented module/component may comprise dedicated circuitry or logic that is permanently configured (e.g., as a special-purpose processor, such as a field programmable gate array (FPGA) or an application-specific integrated circuit (ASIC)) to perform certain operations. A hardware-implemented module/component may also comprise programmable logic or circuitry (e.g., as encompassed within a general-purpose processor or another programmable processor) that is temporarily configured by software to perform certain operations.

Hardware-implemented modules/components can provide information to, and receive information from, other hardware-implemented modules/components. Accordingly, the described hardware-implemented modules/components may be regarded as being communicatively coupled. Where multiple of such hardware-implemented modules/components exist contemporaneously, communications may be achieved through signal transmission (e.g., over appropriate circuits and buses that connect the hardware-implemented modules/components). In examples in which multiple hardware-implemented modules/components are configured or instantiated at different times, communications between such hardware-implemented modules/components may be achieved, for example, through the storage and retrieval of information in memory structures to which the multiple hardware-implemented modules/components have access. For example, one hardware-implemented module/component may perform an operation, and store the output of that operation in a memory device to which it is communicatively coupled. A further hardware-implemented module/component may then, at a later time, access the memory device to retrieve and process the stored output.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules/components that operate to perform one or more operations or functions. The modules/components referred to herein may, in some examples, comprise processor-implemented modules/components.

Similarly, the methods described herein may be at least partially processor-implemented. For example, at least some of the operations of a method may be performed by one or more processors or processor-implemented modules/components. The performance of certain of the operations may be distributed among the one or more processors, not only residing within a single machine, but deployed across a number of machines.

The one or more processors may also operate to support performance of the relevant operations in a “cloud computing” environment or as a “software as a service (SaaS).” For example, at least some of the operations may be performed by a group of computers (as examples of machines including processors), these operations being accessible via a network (e.g., the Internet) and via one or more appropriate interfaces (e.g., APIs).

Examples may be implemented in digital electronic circuitry, or in computer hardware, firmware, or software, or in combinations of them. Examples may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites and interconnected by a communication network.

FIG. 8 is a block diagram of a machine in the example form of a computer system 800 within which instructions 824 may be executed for causing the machine to perform one or more of the methodologies discussed herein. In alternative examples, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU), a GPU, or both), a primary or main memory 804, and a static memory 806, which communicate with each other via a bus 808. The computer system 800 may further include a video display unit 810 (e.g., a liquid crystal display (LCD) or a cathode ray tube (CRT)). The computer system 800 also includes an alphanumeric input device 812 (e.g., a keyboard or a touch-sensitive display screen), a UI navigation (or cursor control) device 814 (e.g., a mouse), a storage unit 816, a signal generation device 818 (e.g., a speaker), and a network interface device 820.

As used herein, the term “processor” may refer to any one or more circuits or virtual circuits (e.g., a physical circuit emulated by logic executing on an actual processor) that manipulates data values according to control signals (e.g., commands, opcodes, machine code, control words, macroinstructions, etc.) and which produces corresponding output signals that are applied to operate a machine. A processor may, for example, include at least one of a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), a Tensor Processing Unit (TPU), a Neural Processing Unit (NPU), a Vision Processing Unit (VPU), a Machine Learning Accelerator, an Artificial Intelligence Accelerator, an Application Specific Integrated Circuit (ASIC), a Field Programmable Gate Array (FPGA), a Radio-Frequency Integrated Circuit (RFIC), a Neuromorphic Processor, a Quantum Processor, or any combination thereof. A processor may be a multi-core processor having two or more independent processors (sometimes referred to as “cores”) that may execute instructions contemporaneously. Multi-core processors may contain multiple computational cores on a single integrated circuit die, each of which can independently execute program instructions in parallel. Parallel processing on multi-core processors may be implemented via architectures like superscalar, VLIW, vector processing, or SIMD that allow each core to run separate instruction streams concurrently. A processor may be emulated in software, running on a physical processor, as a virtual processor or virtual circuit. The virtual processor may behave like an independent processor but is implemented in software rather than hardware.

The storage unit 816 includes a machine-readable medium 822 on which is stored one or more sets of data structures and instructions 824 (e.g., software) embodying or utilized by any one or more of the methodologies or functions described herein. The instructions 824 may also reside, completely or at least partially, within the main memory 804 or within the processor 802 during execution thereof by the computer system 800, with the main memory 804 and the processor 802 also each constituting a machine-readable medium 822.

While the machine-readable medium 822 is shown in accordance with some examples to be a single medium, the term “machine-readable medium” may include a single medium or multiple media (e.g., a centralized or distributed database, or associated caches and servers) that store the one or more instructions 824 or data structures. The term “machine-readable medium” shall also be taken to include any tangible medium that is capable of storing, encoding, or carrying instructions 824 for execution by the machine and that cause the machine to perform any one or more of the methodologies of the present disclosure, or that is capable of storing, encoding, or carrying data structures utilized by or associated with such instructions 824. The term “machine-readable medium” shall accordingly be taken to include, but not be limited to, solid-state memories, and optical and magnetic media. Specific examples of a machine-readable medium 822 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and compact disc read-only memory (CD-ROM) and digital versatile disc read-only memory (DVD-ROM) disks. A machine-readable medium is not a transmission medium.

The instructions 824 may further be transmitted or received over a communications network 826 using a transmission medium. The instructions 824 may be transmitted using the network interface device 820 and any one of a number of well-known transfer protocols (e.g., hypertext transport protocol (HTTP)). Examples of communication networks include a local area network (LAN), a wide area network (WAN), the Internet, mobile telephone networks, plain old telephone (POTS) networks, and wireless data networks (e.g., Wi-Fi and Wi-Max networks). The term “transmission medium” shall be taken to include any intangible medium that is capable of storing, encoding, or carrying instructions 824 for execution by the machine, and includes digital or analog communications signals or other intangible media to facilitate communication of such software.

Although specific examples are described herein, it will be evident that various modifications and changes may be made to these examples without departing from the broader spirit and scope of the disclosure. Accordingly, the specification and drawings are to be regarded in an illustrative rather than a restrictive sense. The accompanying drawings that form a part hereof show by way of illustration, and not of limitation, specific examples in which the subject matter may be practiced. The examples illustrated are described in sufficient detail to enable those skilled in the art to practice the teachings disclosed herein. Other examples may be utilized and derived therefrom, such that structural and logical substitutions and changes may be made without departing from the scope of this disclosure. This detailed description, therefore, is not to be taken in a limiting sense, and the scope of various examples is defined only by the appended claims, along with the full range of equivalents to which such claims are entitled.

Such examples of the subject matter may be referred to herein, individually or collectively, by the term “example” merely for convenience and without intending to voluntarily limit the scope of this application to any single example or concept if more than one is in fact disclosed. Thus, although specific examples have been illustrated and described herein, it should be appreciated that any arrangement calculated to achieve the same purpose may be substituted for the specific examples shown. This disclosure is intended to cover any and all adaptations or variations of various examples. Combinations of the above examples, and other examples not specifically described herein, will be apparent to those of skill in the art upon reviewing the above description.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” and “an” are herein used, as is common in patent documents, to include one or more than one instance.

Unless the context clearly requires otherwise, throughout the description and the claims, the words “comprise,” “comprising,” and the like are to be construed in an inclusive sense, as opposed to an exclusive or exhaustive sense, e.g., in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Where the context permits, words using the singular or plural number may also include the plural or singular number, respectively. Except as otherwise indicated, the word “or” in reference to a list of two or more items, covers all of the following interpretations of the word: any one of the items in the list, all of the items in the list, and any combination of the items in the list.

Although some examples, such as those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence. The term “operation” is used to refer to elements in the drawings of this disclosure for ease of reference and it will be appreciated that each “operation” may identify one or more operations, processes, actions, or steps, and may be performed by one or multiple components.

What is claimed is:

1. A system comprising:
at least one memory that stores instructions; and
one or more processors configured by the instructions to perform operations comprising:
receiving, via a user interface of a continuous integration tool, a user selection of a target state in a software development pipeline;
automatically progressing an increment through a sequence of states of the software development pipeline by:
detecting that a current state of the increment precedes the target state in the sequence of states,
executing one or more automated tests associated with the current state of the increment in the software development pipeline, and
after successful completion of the one or more automated tests and based on detecting that the current state precedes the target state, automatically transitioning the increment to a next state in the sequence of states;
automatically repeating the progressing of the increment until the target state becomes the current state; and
causing presentation, via the user interface, of results data indicating at least the current state and the successful completion of the one or more automated tests.

2. The system of claim 1, wherein the user selection of the target state is a first user selection of a first target state in the software development pipeline, the first user selection is received from a first user device of a first user of the continuous integration tool, and the increment is a first increment, the operations comprising:
receiving, via the user interface and from a second user device of a second user of the continuous integration tool, a second user selection of a second target state in the software development pipeline for a second increment, the second target state differing from the first target state; and
automatically progressing both the first increment and the second increment at least partially through the sequence of states, the first increment automatically transitioned until reaching the first target state and the second increment automatically transitioned until reaching the second target state.

3. The system of claim 1, the operations further comprising:
displaying a plurality of user-selectable options at a user device of a user of the continuous integration tool, the plurality of user-selectable options being displayed via the user interface and associated with respective states in the software development pipeline, wherein the user selection of the target state comprises a selection of one of the plurality of user-selectable options.

4. The system of claim 3, the operations further comprising:
detecting a type of the increment;
identifying the respective states in the software development pipeline that apply to the increment based on the type; and
dynamically generating the plurality of user-selectable options to enable the user to select the target state only from among the respective states that apply to the increment.

5. The system of claim 4, wherein the type of the increment is one of a plurality of different types supported by the continuous integration tool, the plurality of different types comprising at least one of a correction increment or a feature increment.

6. The system of claim 1, the operations further comprising:
triggering the executing of the one or more automated tests associated with the current state in response to detecting that the current state of the increment precedes the target state in the sequence of states.

7. The system of claim 1, the operations further comprising:
detecting an error resulting from the executing of the one or more automated tests; and
in response to detecting the error:
halting the progressing of the increment, and
transmitting an error notification to a user device of a user of the continuous integration tool prior to the transitioning of the increment to the next state in the sequence of states.

8. The system of claim 1, the operations further comprising:
for each transition in the sequence of states, transmitting, to a user device of a user of the continuous integration tool, a notification indicative of the transitioning of the increment to the next state.

9. The system of claim 1, wherein the states of the software development pipeline comprise at least one of a testing state, an integration qualification state, or an integrated state.

10. The system of claim 1, wherein the increment comprises a correction to be integrated into a codeline for release.

11. The system of claim 1, wherein the one or more automated tests comprise at least one of: a unit test, a static test, a dynamic test, a regression test, a performance test, or a security scan.

12. The system of claim 1, the operations further comprising:
displaying, via the user interface, one or more corrective actions to be taken by a user of the continuous integration tool with respect to the increment.

13. The system of claim 12, the operations further comprising:
generating the one or more corrective actions based on an outcome of the one or more automated tests.

14. The system of claim 1, the operations further comprising:
receiving, via the user interface and from a user device of a user of the continuous integration tool, a request to progress the software development pipeline for the increment to the target state; and
in response to receiving the request and based on the user selection of the target state, triggering the progressing of the increment.

15. A computer-implemented method performed by a computer system comprising a memory and at least one hardware processor, the computer-implemented method comprising:
receiving, via a user interface of a continuous integration tool, a user selection of a target state in a software development pipeline;
automatically progressing an increment through a sequence of states of the software development pipeline by:
detecting that a current state of the increment precedes the target state in the sequence of states,
executing one or more automated tests associated with the current state of the increment in the software development pipeline, and
after successful completion of the one or more automated tests and based on detecting that the current state precedes the target state, automatically transitioning the increment to a next state in the sequence of states;
automatically repeating the progressing of the increment until the target state becomes the current state; and
causing presentation, via the user interface, of results data indicating at least the current state and the successful completion of the one or more automated tests.

16. The computer-implemented method of claim 15, wherein the user selection of the target state is a first user selection of a first target state in the software development pipeline, the first user selection is received from a first user device of a first user of the continuous integration tool, and the increment is a first increment, the method comprising:
receiving, via the user interface and from a second user device of a second user of the continuous integration tool, a second user selection of a second target state in the software development pipeline for a second increment, the second target state differing from the first target state; and
automatically progressing both the first increment and the second increment at least partially through the sequence of states, the first increment automatically transitioned until reaching the first target state and the second increment automatically transitioned until reaching the second target state.

17. The computer-implemented method of claim 15, further comprising:
displaying a plurality of user-selectable options at a user device of a user of the continuous integration tool, the plurality of user-selectable options being displayed via the user interface and associated with respective states in the software development pipeline, wherein the user selection of the target state comprises a selection of one of the plurality of user-selectable options.

18. One or more non-transitory computer-readable media storing computer-executable instructions that, when executed by a computing system, cause the computing system to perform operations comprising:
receiving, via a user interface of a continuous integration tool, a user selection of a target state in a software development pipeline;
automatically progressing an increment through a sequence of states of the software development pipeline by:
detecting that a current state of the increment precedes the target state in the sequence of states,
executing one or more automated tests associated with the current state of the increment in the software development pipeline, and
after successful completion of the one or more automated tests and based on detecting that the current state precedes the target state, automatically transitioning the increment to a next state in the sequence of states;
automatically repeating the progressing of the increment until the target state becomes the current state; and
causing presentation, via the user interface, of results data indicating at least the current state and the successful completion of the one or more automated tests.

19. The one or more non-transitory computer-readable media of claim 18, wherein the user selection of the target state is a first user selection of a first target state in the software development pipeline, the first user selection is received from a first user device of a first user of the continuous integration tool, and the increment is a first increment, the operations comprising:
receiving, via the user interface and from a second user device of a second user of the continuous integration tool, a second user selection of a second target state in the software development pipeline for a second increment, the second target state differing from the first target state; and
automatically progressing both the first increment and the second increment at least partially through the sequence of states, the first increment automatically transitioned until reaching the first target state and the second increment automatically transitioned until reaching the second target state.

20. The one or more non-transitory computer-readable media of claim 18, the operations further comprising:
displaying a plurality of user-selectable options at a user device of a user of the continuous integration tool, the plurality of user-selectable options being displayed via the user interface and associated with respective states in the software development pipeline, wherein the user selection of the target state comprises a selection of one of the plurality of user-selectable options.
